(19) United States
(12) Patent Application Publication
(10) Pub. No.: US 2013/0030748 A1
(43) Pub. Date: Jan. 31, 2013

(54) METHOD FOR DETERMINING A DOSED, OR METERED, VOLUME OF AN AUTOMATIC PERISTALTIC SAMPLE TAKER

(71) Applicants: Jochen Reith, Leonberg (DE); Matthias Knopp, Weissach-Flacht (DE); Fabian Manzer, Markgroingen (DE); Florian Fetz, Stuttgart (DE)

(72) Inventors: Jochen Reith, Leonberg (DE); Matthias Knopp, Weissach-Flacht (DE); Fabian Manzer, Markgroingen (DE); Florian Fetz, Stuttgart (DE)

(73) Assignee: Endress + Hauser Conducta Gesellschaft fur Mess- und Regeltechnik mbH + Co. KG, Gerlingen (DE)

(21) Appl. No.: 13/559,705

(22) Filed: Jul. 27, 2012

(30) Foreign Application Priority Data
Jul. 27, 2011 (DE) 10 2011 079 927.3

(51) Int. Cl. G06F 17/00; G01F 25/00

(52) U.S. Cl. 702/100

(57) ABSTRACT

A method for determining a dosed, or metered, volume of an automatic peristaltic sample taker, in the case of which a measured, dosed, or metered, volume of the peristaltic sample taker is corrected by means of a calibration map. In order to improve accuracy in the determining of the dosed, or metered, volume, during a calibration phase, the calibration map is corrected by means of a correction curve, which depends on a negative pressure arising in the suction region of the peristaltic sample taker.

The invention relates to a method for determining a dosed, or metered, volume of an automatic peristaltic sample taker, in the case of which a measured, dosed, or metered, volume of the peristaltic sample taker is corrected by means of a calibration map.

From DE 20 2009 006 821 U1, a sample taking device for water and other liquids is known, wherein the sample taking device has a sample receiving container for accommodating a particular amount of sample liquid as the sample to be dispensed, wherein the sample to be dispensed is extracted from a supply amount with a pump for extraction of the sample liquid via a suction line. For introducing the sample liquid into the sample receiving container, the pump is connected via a line with the sample receiving container. In such case, a control system determines the amount of the sample to be sucked in. The pump sucks the sample liquid from the supply amount with a constant RPM, whereby the amount of the sample liquid to be dispensed is determined alone by the run time of the pump. In the suction line to the pump, a measuring path is arranged for determining the transport amount of the sample liquid per unit time or per revolution of the pump. The transport amount per unit time is determined by the control system. Due to the fact that, before each sample taking, the transport time is specifically determined, the exact dosed, or metered, volumes for each sample and each hose used must be individually determined. There is no calibrating of the dosed, or metered, volumes as a function of the viscosities, degrees of fouling and the suction height of the sample liquid.

From U.S. Pat. No. 6,081,065 A, a pump system is known, which uses a peristaltic pump, by means of which a predetermined amount of liquid is dosed, or metered, through a hose into a container. In such case, the position of the liquid in the hose is registered by determining changes in the deformation of the hose. The liquid is, in such case, pumped through the hose in a manner that effects a deformation and that has a relationship to the flow of liquid under control of the pump. The registered deformation is used to detect the pumping of liquid to a particular point. The deformation is, in such case, registered via a changing number of pulses, which occur when the liquid moves through the pipeline, wherein a rise in the amplitude of the pulses shows that liquid is nearing the pump.

Such automatic peristaltic sample takers bring about a volume flow rate of the sample liquid, which possesses a strong dependence on various parameters, such as, for example, temperature, peristaltic hose age, peristaltic hose tolerances as well as peristaltic hose geometry. The negative pressure reigning in the suction region of the peristaltic sample taker is, in the case of automatic peristaltic sample takers with a connected suction hose (whose length most often amounts to several meters), determined by the resulting suction height, the geometrical parameters of the suction hose as well as the density of the medium, which is to flow. Such peristaltic sample takers must enable dosings, or meterings, with high accuracies after a one-time calibrating over the entire lifetime of the peristaltic sample taker, performance which must also be provided in the case of changing suction heights, suction hose geometries and transport media. Based on the known calibration at a single suction height, only the tolerances of the currently used peristaltic hose at this one operating point can be compensated. Under these conditions, varying suction heights, which, for example, are brought about by fluctuating water levels, suction hose deformations as well as fluctuating density of the medium lead, however, to a considerable reduction in the dosing, or metering, accuracy of the dosed, or metered, volume.

An object of the invention is thus to provide a method for determining a dosed, or metered, volume of an automatic peristaltic sample taker, which, after a one-time calibration, assures a high dosing, or metering, accuracy in the case of the particular dosed, or metered, volume over the entire lifetime of the automatic peristaltic sample taker.

The object is achieved according to the invention by features including that, during a calibration phase, a calibration map is adjusted by means of a correction curve, which depends on a negative pressure arising in the suction region of the peristaltic sample taker. This has the advantage that the material properties of the suction hose, by which the negative pressure of the peristaltic sample taker is decisively influenced, are taken into consideration in the determining of the dosed, or metered, volume. The individual hose tolerances, which are especially based upon manufacturing related scattering of the hose elasticity, strongly influence the cross sectional changes in the case of the transporting of medium as a function of the supplied negative pressure. The given negative pressure is dominated during the dosing procedure by the suction height and the density of the medium according to the Bernoulli's energy equation as well as the pressure loss caused by friction in the suction hose in the form of head loss according to Darcy-Weisbach. Thus, the unpredictable hose tolerances can be taken into consideration with high accuracy in the calibrating of the dosed, or metered, volumes. This taking into consideration of the material properties enables the correction of the dosed, or metered, volume for all possible pressure conditions via a one-time calibrating.

Advantageously, the correction curve is determined from at least two calibration values measured at different negative pressures. Via the use of two calibration values, it is assured that various occurring negative pressures enter into the ascertaining of the correction curve. In such case, a multiplicity of calibration values increases the accuracy of the correction curve as a function of the negative pressures arising in the suction hose.

In an embodiment, dosed, or metered, volumes are produced at different negative pressures by varying suction height for individual sample takings. Thus, calibration occurs only at different suction heights. The negative pressures are measured with a pressure sensor in the calibration.

In a variant, the correction curve characterizing the dependence of a calibration value on the negative pressure extends as a straight line. In the case of the adjusting by means of a line, the calibration map is shifted linearly in vertical direction in a manner dependent on the negative pressure.

Alternatively, the correction curve characterizing the dependence of a calibration value on the negative pressure does not extend linearly. Such a non-linear correction curve improves the correction accuracy of the calibration map, since it permits a comprehensive deformation of the calibration map.

In a further development, the correction curve is ascertained based on estimation of model parameters via a non-linear, weighted regression from calibration values determined at a multiplicity of suction heights. Due to this method of the non-linear, weighted regression, a correction curve between the calibration values is ascertained, which need not necessarily intersect with the individual calibration values.

In a variant, in the ascertaining of each calibration value at a negative pressure, a difference between the measured dosed, or metered, volume and a desired volume is determined.

Advantageously, the calibration map depends on geometry of the suction hose and/or hose age and/or medium to be transported by the peristaltic sample taker. Thus, besides the negative pressure, as many parameters as desired can be taken into consideration in the creation of the calibration map. The more parameters that are taken into consideration, the more exact the calibration map becomes, and this contributes to a more exact correction of the dosed, or metered, volume of the automatic peristaltic sample taker.

In an additional form of embodiment, the uncorrected calibration map represents dosed, or metered, volumes of a multiplicity of peristaltic sample takers versus peristaltic hose age at different negative pressures. This uncorrected calibration map is, in such case, stored in a control device, which operates the peristaltic sample taker. It is obtained from a large number of samples of peristaltic sample takers, wherein these results are ascertained only once, and then stored in the control devices of the most varied of peristaltic sample takers.

The invention lends itself to numerous forms of embodiment. One of these will now be explained in greater detail based on the appended drawing, the figures of which show as follows:

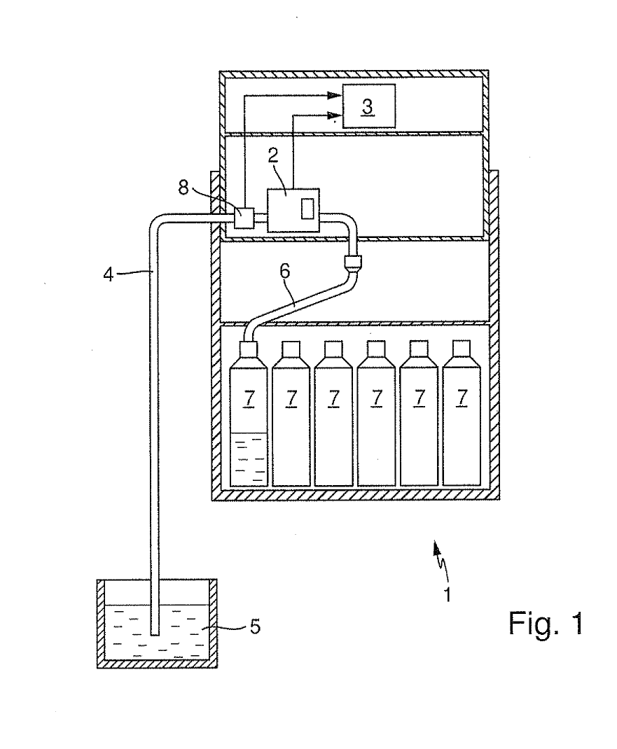

FIG. 1 schematic representation of an apparatus for taking a sample by means of a peristaltic sample taker;

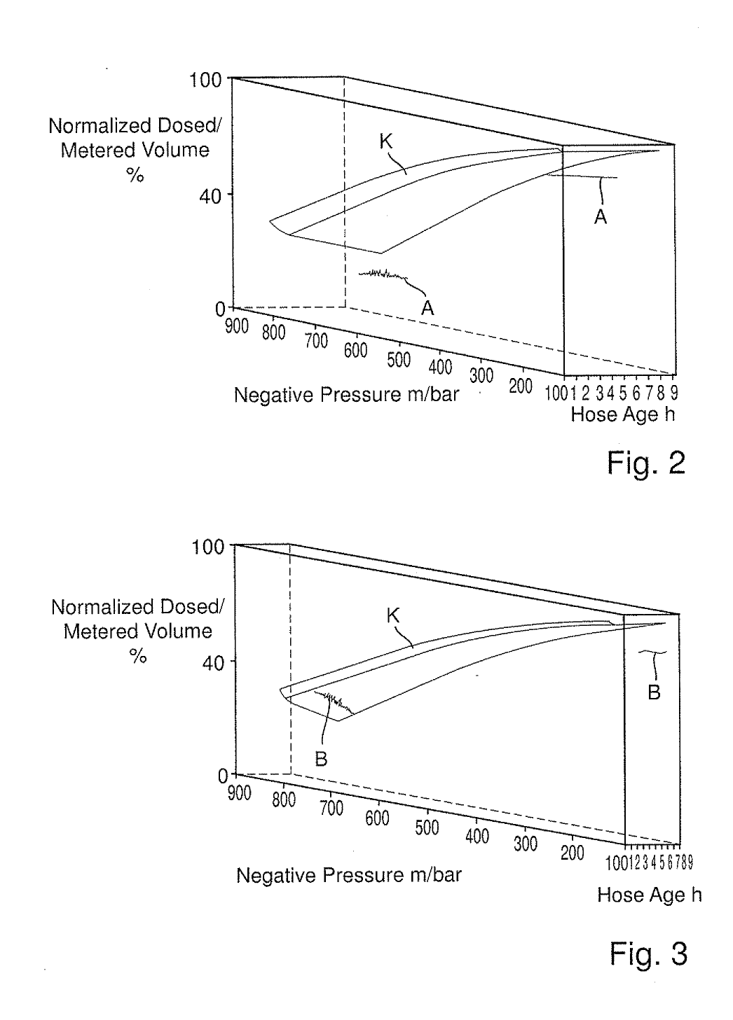

FIG. 2 behavior of a first peristaltic hose in the case of two different negative pressures according to the state of the art;

FIG. 3 behavior of a second peristaltic hose in the case of different negative pressures according to the state of the art;

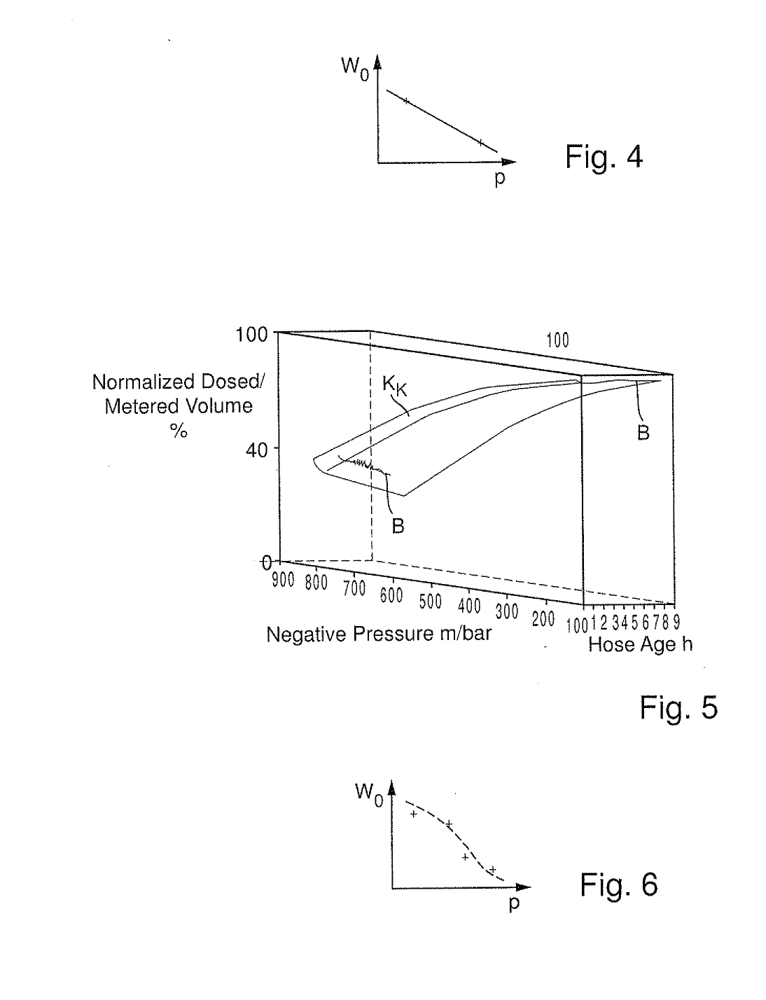

FIG. 4 a first correction curve;

FIG. 5 calibration map of the second peristaltic hose corrected with the first correction curve, based on a one-time calibrating; and

FIG. 6 a second correction curve.

Equal features are designated with equal reference characters.

FIG. 1 shows a schematic drawing of an automatic peristaltic sample taker 1, including a pump 2, which especially is embodied as a peristaltic pump, wherein in or at the pump 2, a control unit 3 is arranged. The pump 2 is connected with a suction line 4, which, for taking the sample, extends into a liquid reservoir 5. Suction line 4 can be up to 30 m long and is composed of a viscose material with individual hose properties. Furthermore, the pump 2 is connected with a transport line 6, which borders on a sample holder 7, into which the sample taken from the liquid reservoir 5 is filled. A pressure sensor 8 measures the negative pressure p in the suction line 4. The functional principle of the peristaltic sample taker is based on compression or squeezing of the flexible suction hose 2 of flexible tubing at one or more locations and by moving the compressed location in the desired transport direction for the liquid. The movement of the compressed location is implemented with the assistance of a pump rotor (not further illustrated), on whose periphery roll shaped, rotor rolls are located.

Stored in the control unit 3 is a calibration map K, which corresponds to an averaged hose behavior of a multiplicity of automatic peristaltic sample takers 1. For determining the average hose behavior, in the case of each peristaltic sample taker 1, the normalized dosed, or metered, volume at different negative pressures was determined over the peristaltic hose age in the case of otherwise approximately identical conditions. This calibration map K is utilized for all measurements of the dosed, or metered, volume over the lifetime of a peristaltic sample taker 1. The “normalized dosed, or metered, volume” means, here, referenced to a volume V=100 ml achieved with the pump moving sample at constant RPM. This 100 ml sample is shown in FIG. 2 and in FIG. 3 as 100%. The negative pressure shown in the calibration map K in FIG. 2 and FIG. 3 represents head loss according to Darcy-Weisbach based on suction height and density of the medium according to Bernoulli's energy equation as well as the pressure loss caused by friction in the suction line 4.

FIG. 2 shows the behavior of a first suction hose, peristaltic hose A, as a function of different negative pressures, and FIG. 3 the behavior of a second peristaltic hose B likewise at different negative pressures. As is evident from FIG. 2, the behavior of peristaltic hose A deviates from that of the calibration map K and is negative, as well as slightly dependent on negative pressure. In contrast, it is evident from FIG. 3 that the behavior of the second peristaltic hose B different negative pressures has an essentially greater deviation from the average hose behavior of calibration map K. This deviation from the average hose behavior is essentially greater at smaller negative pressures than at larger negative pressures.

As can thus be recognized from FIGS. 2 and 3, the behavior influenced by individual hose properties in the case of changing negative pressure strongly deviates from the average hose characteristic illustrated by calibration map K. This is based, among other things, on manufacturing related scattering of hose elasticity, which strongly influences cross sectional changes as a function of the supplied negative pressure in the case of transporting medium.

In order to account for this dependence on negative pressure and, as a result thereof, also on the material behavior of the suction hose B, it is proposed to compensate for the strong dependence of the dosed, or metered, volume on the given negative pressure, as mainly resulting from suction height, hose geometry and density of the medium. Thus, a correction curve is determined, which is ascertained from individual calibration measurements at different suction heights. During this one-time calibration, first, at start-up of the peristaltic sample taker 1, an actual volume V_{actual,kal} is detected and stored in the control unit 3 along with a predetermined, desired volume V_{desired,kal}. In such case, a difference ΔV is ascertained between the desired volume V_{desired,kal} and the actual volume V_{actual,kal}:

ΔV=V_{desired,kal}−V_{actual,kal} (1)

The volume already compensated according to this per se known method

V=V_{actual,kal}+V (2)

is now further corrected to a volume V_{corr} as follows:

$${V}_{corr} = {\vec{w}}^{T} \cdot \vec{V} = ( \begin{matrix}{w}_{0} & … & {w}_{N}\end{matrix} ) \cdot ( \begin{matrix}{V}^{0} \\ {V}^{1} \\ ⋮ \\ {V}^{N}\end{matrix} ) = ( \begin{matrix}{w}_{0} & … & {w}_{N}\end{matrix} ) \cdot ( \begin{matrix}1 \\ V \\ ⋮ \\ {V}^{N}\end{matrix} ) \qquad ( 3 )$$

In such case, N is the order of the correction and \vec{w} are negative pressure dependent coefficients.

For better understanding, a simpler calibration Vₖₒᵣᵣ of the two peristaltic hoses A and B will now be considered based on calibration measurements at only two different suction heights. For clear presentation, the order of the correction is selected as N=0. For the second coefficient, by way of simplification, w₁=1 should hold. The coefficient w¹ is obtained via linear interpolation or extrapolation in the possible negative pressure range, which the peristaltic sample taker 1 to be considered can display. From this, there results from the above equation

$${V}_{corr \_ 1} = {\vec{w}}^{T} \cdot \vec{V} = ( \begin{matrix}{w}_{0} & {w}_{1}\end{matrix} ) \cdot ( \begin{matrix}1 \\ V\end{matrix} ) = V + {w}_{0} ( p ) \qquad ( 4 )$$

In such case, the corrected volume V_{corr} is a function of the negative pressure p. Based on the calibration values determined at the two suction heights, a linear dependence of the calibration values on the suction height and, thus, on the negative pressure p is obtained. This is illustrated in FIG. 4, where the correction line for w₀₍ₚ₎ was located via calibration values at two different suction heights. The application of such a correction curve in the case of long term use of peristaltic hoses A and B enables a dosing, or metering, with a relative deviation from the predetermined desired volume V_{desired} of under 5%.

For better clarification, FIG. 5 shows the corrected calibration map K_{K} for the peristaltic hose B. Based on the correction curve ascertained as a straight line (FIG. 4), the calibration map K, as presented in FIG. 3, is shifted in a pressure-dependent manner as a result of the calibration. This corrected calibration map K_{K} is stored in the control unit 3, and in the taking of each sample via peristaltic sample taker 1, taken into consideration for the correct determining of the dosed, or metered, volume.

In the case of the determining of the correction curve, also a multiplicity of calibration points can be ascertained at a corresponding number of suction heights. In FIG. 6, four calibration values were ascertained at four different suction heights in the suction hose B. In such case, the correction curve is determined based, for example, on a weighted, non-linear regression, which empirically determines the unknown model parameters. Such a non-linear correction function is presented in FIG. 6, where the correction function need not necessarily intersect the calibration values, which were found empirically. The weightings of the individual calibration values can be guided by the given measurement uncertainties.

Based on the discussed method, a highly accurate metering of the dosed, or metered, volume with an automatic peristaltic dose taker is assured even in the case of strongly fluctuating negative pressure p. With this, changes in the suction height, the hose geometry and the density of the medium can be compensated in the case of the individual dosing, or metering, events. Especially, an improvement of the dosing, or metering, can be achieved, when, during a calibration procedure, a registering of two calibration values is performed once at two different negative pressures or suction heights in the suction hose B.

1-8. (canceled)

9. A method for determining a dosed, or metered, volume of an automatic peristaltic sample taker, comprising the steps of:
correcting a measured, dosed, or metered, volume of the peristaltic sample taker by means of a calibration map, and
adjusting the calibration map, during a calibration phase, by means of a correction curve, which depends on a negative pressure arising in the suction region of the peristaltic sample taker.

10. The method as claimed in claim 9, wherein:
the correction curve is determined from at least two calibration values measured at different negative pressures.

11. The method as claimed in claim 9, wherein:
dosed, or metered, volumes are produced at different negative pressures by varying suction height for individual sample takings.

12. The method as claimed in claim 10, wherein:
the correction curve characterizing the dependence of the calibration value on the negative pressure extends as a straight line.

13. The method as claimed in claim 9, wherein:
the correction curve characterizing the dependence of a calibration value on the negative pressure (p) extends non-linearly.

14. The method as claimed in claim 13, wherein:
the correction curve is ascertained based on estimation of model parameters via a non-linear, weighted regression from calibration values determined at a multiplicity of suction heights.

15. The method as claimed in claim 9, wherein:
the calibration map depends on geometry of the suction hose and/or hose age and/or medium to be transported by the peristaltic sample taker.

16. The method as claimed in claim 9, wherein:
the uncorrected calibration map represents dosed, or metered, volumes of a multiplicity of peristaltic sample takers versus peristaltic hose age at different negative pressures.
